(19) United States
(12) Patent Application Publication
(10) Pub. No.: US 2021/0348928 A1
(43) Pub. Date: Nov. 11, 2021

(54) MULTI-POLICE-OFFICER COLLABORATIVE ROUND-UP TASK ALLOCATION AND PATH PLANNING METHOD UNDER CONSTRAINT OF ROAD NETWORK

(71) Applicant: WUHAN UNIVERSITY OF SCIENCE AND TECHNOLOGY, Hubei (CN)

(72) Inventors: Yang CHEN, Hubei (CN); Zifeng HU, Hubei (CN); Huaiyu WU, Hubei (CN); Zhihuan CHEN, Hubei (CN); Xiaojun TONG, Hubei (CN)

(73) Assignee: WUHAN UNIVERSITY OF SCIENCE AND TECHNOLOGY, Hubei (CN)

(21) Appl. No.: 17/306,971

(22) Filed: May 4, 2021

(30) Foreign Application Priority Data
May 6, 2020 (CN) 202010372605.9

(51) Int. Cl. G01C 21/34

(52) U.S. Cl. CPC G01C 21/3407; G01C 21/3492

(57) ABSTRACT

A multi-police-officer collaborative round-up task allocation and path planning method under the constraint of a road network, including: acquiring a road topological map G of the road network; acquiring police officer distribution information and information of a task target location in the G of the road network; according to the position where the task target appears, a set of nodes that the task target is next likely to reach are determined; acquiring the movement speed of police officers and the task target; confirming a set of police officers to be assigned according to an interception point set and the movement speed of the police officers and the task target; calculating the congestion degree of each intersection in the interception point set; building a multi-police-officer collaborative round-up task allocation and path planning optimization model; solving the optimization model to obtain a multi-police-officer collaborative round-up task allocation and path planning scheme.

### CROSS-REFERENCE TO RELATED APPLICATION

This application claims the priority benefit of China application serial no. 202010372605.9, filed on May 6, 2020. The entirety of the above-mentioned patent application is hereby incorporated by reference herein and made a part of this specification.

### TECHNICAL FIELD

The present disclosure relates to an artificial intelligence technology, in particular to a multi-police-officer collaborative round-up task allocation and path planning method under the constraint of a road network.

### BACKGROUND

In order to fulfill the task of capturing a suspicious target, collaborative police officers need to move to the place where the suspicious targets may appear in the next step, and then capture the suspicious target. The success of the round-up is inevitably affected by many external factors, such as road traffic conditions, the pedestrian volume of the round-up point, the terrain of the round-up point and so on. The existing literature fails to consider the above effects, so it is urgent to design the round-up strategy and deploy the police force in combination with the actual capture scene. In the existing literature, the round-up scenes are relatively simple, and can be roughly divided into the following two categories: one is to estimate the state of the escaping target by using Markov model or other methods, assuming that both the escaping target and the round-up robot can only move towards the adjacent grid in the grid map; the other is to estimate the movement trajectory of the escaping target online by using EKF without the constraint of a road network, which ignores the constraint of the real road network. In the actual capture process, the suspicious target and police officers can only move in strict accordance with a real road network, and it is difficult to predict the trajectory in the case of many intersections.

### SUMMARY OF THE DISCLOSURE

The technical problem to be solved by the present disclosure is to provide a multi-police-officer collaborative round-up task allocation and path planning method under the constraint of a road network aiming at the defects in the prior art.

The technical solution adopted by the present disclosure for solving the technical problem is as follows: the multi-police-officer collaborative round-up task allocation and path planning method under the constraint of the road network includes the following steps:

1) acquiring a road topological map G=(V, E) of the road network, wherein edges E of the map denote roads, and nodes V of the map denote intersections;

2) acquiring police officer distribution information and information of a task target location in the G of the road network;

3) according to the position where a task target appears in combination with the road topological map, determining a set of nodes that the task target is next likely to reach, and defining the set of nodes as an interception point set I;

4) acquiring the movement speed of police officers and the task target, wherein the movement speed of the task target is calculated from time position information of the task target, collected by a camera in a real road network;

5) confirming a set A of police officers to be assigned according to the interception point set and the movement speed of the police officers and the task target; calculating the shortest distances and the corresponding time from the task target and police officers to the interception points in the road network, wherein if for all interception points, the arrival time of a certain police officer is longer than the arrival time of a suspicious target, the police officer is removed from an assignment list;

6) calculating the congestion degree of each intersection in the interception point set;

7) building a multi-police-officer collaborative round-up task allocation and path planning optimization model under the constraint of the road network with the goal of minimum total round-up distance of all police officers in the set of police officers to be assigned and lowest escape probability of the task target;

8) solving the multi-police-officer collaborative round-up task allocation and path planning optimization model under the constraint of the road network by using the above constraint conditions to obtain a multi-police-officer collaborative round-up task allocation and path planning scheme.

According to the above solution, in the step 2), the task target location is detected and recognized by a camera in the road network.

According to the above solution, in the step 6), the congestion degree of each intersection in the interception point set is calculated by adopting the following equation:

$${α}_{j} = \frac{{c}_{j}}{{c}_{max}}$$

wherein αⱼ denotes a congestion index of the jth interception point; cⱼ denotes a total amount of a pedestrian volume and a traffic flow at the intersection corresponding to the jth interception point at the current moment; cₘₐₓ denotes a maximum value of the total number of the pedestrian volume and the traffic flow corresponding to all interception points at the current moment.

According to the above solution, in the step 7), a multi-objective function of the multi-police-officer collaborative round-up task allocation and path planning optimization model under the constraint of the road network is as follows:

7.1) a total round-up distance of all police officers in the set A of police officers to be assigned:

$${f}_{1} = {\sum }_{j = 1}^{N} {\sum }_{i = 1}^{K} {x}_{ij} {D}_{ij}$$

7.2) escape probability of the task target: a total escape probability of the suspicious target is an average value of escape probabilities of all interception points, which is calculated as follows:

$${f}_{2} = \frac{1}{N} {\sum }_{j = 1}^{N} \frac{1}{( 2 - 0.6 {α}_{j} ) {\sum }_{i = 1}^{K} {x}_{ij}}$$

According to the above solution, in the step 7), constraint conditions of the multi-police-officer collaborative round-up task allocation and path planning optimization model under the constraint of the road network are as follows:

7.3) establishing the constraint conditions of the optimization model;

7.3.1) to maximize police calls, all police officers belonging to the set A must and can only be assigned to a certain interception point to perform the round-up task;

$${\sum }_{j = 1}^{N} {x}_{ij} = 1 , ( i = 1 , 2 , \text{…} , K )$$

wherein xᵢⱼ=1 (i=1, 2, . . . , K; j=1, 2, . . . N) denotes the assignment of the ith police officer in the A to the jth interception point, otherwise xᵢⱼ=0, N is a total number of interception points of the interception point set, and K is a total number of police officers in the set A to be assigned;

7.3.2) it is required that a police officer assigned to a certain interception point must reach that interception point before the suspicious target

$$\frac{{D}_{ij} {x}_{ij}}{{v}_{p}} \leq \frac{{d}_{j}}{{v}_{a}} ( i = 1 , 2 , \text{…} , K ; j = 1 , 2 , \text{…} , N )$$

wherein Dᵢⱼ denotes a shortest distance from the ith police officer in the A to the jth interception point under the constraint of the road network, and dⱼ denotes a shortest distance from the position where the suspicious target appears to the jth interception point under the constraint of the road network; vₚ is the speed of each police officer, and vₐ is the speed of the task target;

7.3.3) xᵢⱼ is a variable of 0, 1;

xᵢⱼ={0,1}

According to the above solution, in the step 8), the optimization model is solved by using a NSGA-II algorithm, and a geometric cluster center of a Pareto solution set is selected as a final police officer assignment scheme.

The beneficial effects of the present disclosure are as follows:

The present disclosure not only takes into account the constraint of the real road network, but also takes into account the effect of different number of people for capturing and capture environments on the escape probability of a suspicious target, and builds a multi-target optimization model with minimizing the total running course of all police officers and the escape probability of the suspicious target as the objective function, the model reasonably assigns police officers to interception points for waiting for capturing according to time, environmental complexity, and constraints on walking-restricted road segments, while optimizing the planned path of movement of various police officers to corresponding interception points on the road network.

### BRIEF DESCRIPTION OF THE DRAWINGS

The present disclosure will now be further described in conjunction with the accompanying drawings and embodiments, and in the accompanying drawings:

FIG. 1 is a flowchart of a method according to an embodiment of the present disclosure;

FIG. 2 is a schematic diagram of a topological map according to an embodiment of the present disclosure;

FIG. 3 is a schematic diagram of an intercepting model according to an embodiment of the present disclosure;

FIG. 4 is a round-up flow schematic diagram according to an embodiment of the present disclosure;

FIG. 5 is a schematic diagram of spatial distribution of a non-inferior solution according to an embodiment of the present disclosure;

FIG. 6 is a diagram of an intercepting model of an embodiment of the present disclosure;

FIG. 7(a)-7(d) are schematic diagrams of police officer assignment and path planning according to an embodiment of the present disclosure.

### DETAILED DESCRIPTION OF THE EMBODIMENTS

In order to make the objects, technical solutions and advantages of the present disclosure clearer, the present disclosure will be described in further detail below in combination with the embodiments. It should be understood that the specific embodiments described herein are merely used to explain the present disclosure and are not intended to limit the present disclosure.

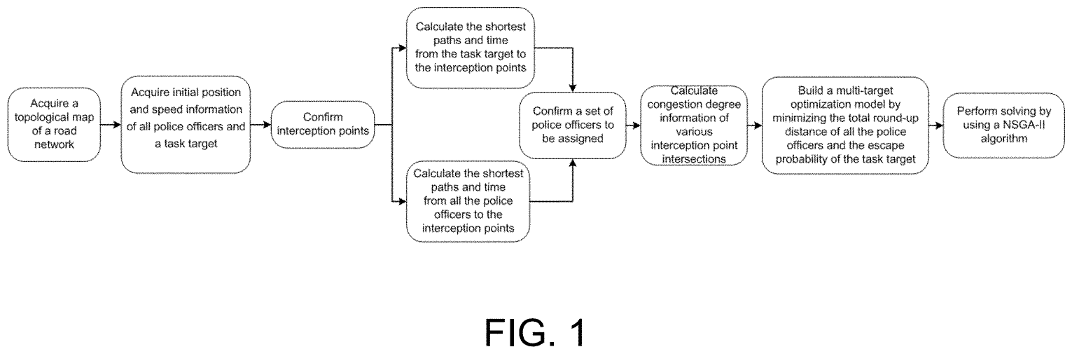

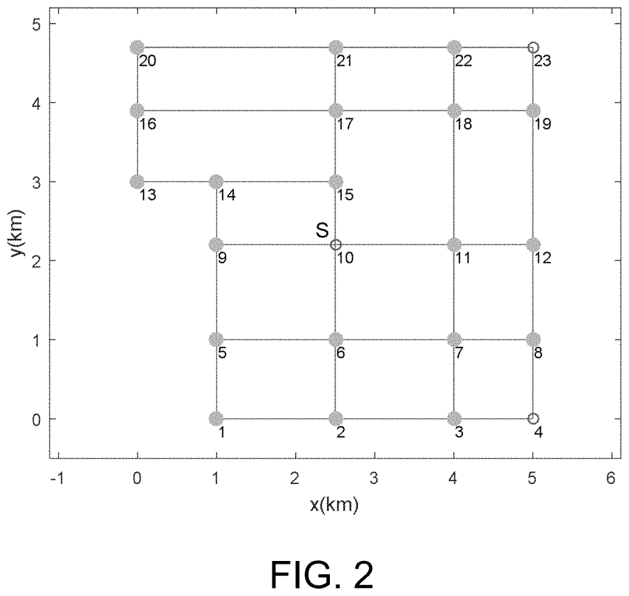

As shown in FIG. 1, a multi-police-officer collaborative round-up task allocation and path planning method under the constraint of a road network includes the following steps:

1) acquiring a road topological map G=(V, E) of the road network, wherein edges E of the map denote roads, and nodes V of the map denote intersections;

2) acquiring police officer distribution information and information of a task target location in the G of the road network, wherein the information of the task target location is detected and recognized by a camera in the road network;

3) according to the position where a task target appears in combination with the road topological map, determining a set of nodes that the task target is next likely to reach, and defining the set of nodes as an interception point set I;

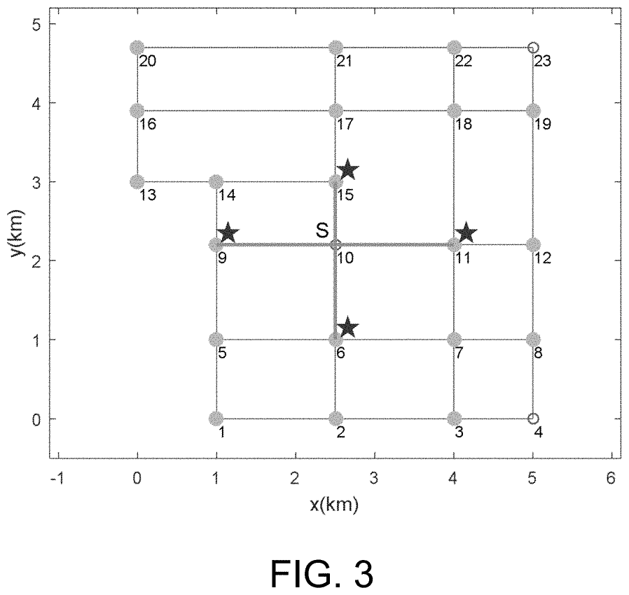

The capture strategy adopted in the present disclosure is to intercept all possible escape paths of the suspicious target to achieve round-up, so all neighboring nodes connected to the initial position of the suspicious target are set as interception points. As shown in FIG. 3, S denotes the position where the suspicious target appears, the thick solid lines denote the paths that the suspicious target may choose after leaving from the current node, the asterisks in denote the set of nodes that the suspicious target may reach at the next moment, and the set of nodes is defined as the interception point set I. In FIG. 3, the suspicious target appears at intersection 10, next, the suspicious target may randomly appear at intersections 6, 9, 11, 15, and then these four intersections form a round-up interception point set I, i.e. I={6,9,11,15}.

In this embodiment, it is assumed that a suspicious target has scouting capabilities, in order to ensure that the capture process does not cause alertness of the suspicious target, it is required that all police officers cannot move on the path that the suspicious target may walk (the traffic road segments from intersections 10 to intersections 6, 9, 11, 15 in FIG. 3 are paths that the suspicious target may walk, all police officers are restricted from walking on these paths during the capture process). Although adding walking-restricted road segments makes some police officers unable to meet time constraints and increases the difficulty of police officer task allocation and path planning, it is more consistent with actual capture scenarios.

4) acquiring the movement speed of the police officers and the task target, wherein the movement speed of the task target is calculated from the time position information of the task target, collected by the camera in the real road network;

Since the police officer walking-restricted road segments are incorporated in the embodiment (requiring that all police officers cannot move on the paths the suspicious target may walk), infinite weighting of the walking-restricted road segments in the distance weight matrix is required for shortest distance calculation using Dijkstra's algorithm. Taking FIG. 3 as an example, 10 to {6, 9, 11, 15} and {6, 9, 11, 15} and to 10 in the distance weights are set to infinity;

5) confirming a set A of police officers to be assigned according to the interception point set and the movement speed of the police officers and the task target; calculating the shortest distances from the task target and the police officers to interception points in the road network and the corresponding time, wherein if for all interception points, the arrival time of a certain police officer is longer than the arrival time of a suspicious target, the police officer is removed from an assignment list;

6) calculating the congestion degree of each intersection in the interception point set;

$${α}_{j} = \frac{{c}_{j}}{{c}_{max}}$$

wherein αⱼ denotes a congestion index of the jth interception point; cⱼ denotes a total amount of a pedestrian volume and a traffic flow at the intersection corresponding to the jth interception point at the current moment; cₘₐₓ denotes a maximum value of a total amount of the pedestrian volume and the traffic flow corresponding to the densest intersection of all intercepted intersections at the current moment;

Larger α indicates that the environment is more crowded, it is less suitable for capture and the escape probability for a suspicious target is high, and theoretically, more police officers are required to carry out capture. Also the number of police officers assigned to each interception point has an influence on the capture success rate, the larger the number of people for capture is, the higher the capture success rate is at the same congestion index, and a function of the escape probability Pⱼ of a suspicious target at the jth interception point changing with the congestion index αⱼ of this interception point and the number nⱼ of people for capture assigned to this interception point is shown below:

$${P}_{j} = \frac{1}{{( 2 - 0 .6 {α}_{j} )}^{{n}_{j}}}$$

7) building a multi-police-officer collaborative round-up task allocation and path planning optimization model under the constraint of the road network with the goal of minimum total round-up distance of all police officers in the set of police officers to be assigned and lowest escape probability of the task target;

Parameter Definitions:

The number of police officers is denoted as M, the number of interception points is denoted as N, and when assuming that the movement speed of the police officers on the road network is vₚ=40 km/h, the movement speed of the suspicious target is vₐ=10 km/h.

In an actual capture scenario, there may be a small number of police officers that are far away from all interception points and cannot reach at least a certain interception point before the suspicious target, then these police officers will not be involved in task allocation. A real variable is defined as AϵR^{1×K}, indicating that the rest of K police officers in the M police officers can be assigned tasks, wherein K≤M.

A 0-1 matrix xϵR^{K×N} is introduced, xᵢⱼ==1 (i=1, 2, . . . , K; j=1, 2, . . . , N) indicates that the ith police officer in the A is assigned to the jth interception point, otherwise xᵢⱼ=0.

Real variables DϵR^{K×N} and dϵR^{1×N} are defined. Wherein Dᵢⱼ denotes the shortest distance from the ith police officer in the A to the jth interception point under the constraint of the road network, and d₁ denotes the shortest distance from the position where the suspicious target appears to the jth interception point under the constraint of the road network.

7.1) a total round-up distance of all police officers in the set of police officers to be assigned:

$${f}_{1} = {\sum }_{j = 1}^{N} {\sum }_{i = 1}^{K} {x}_{ij} {D}_{ij}$$

7.2) escape probability of the task target: a total escape probability of the suspicious target is an average value of escape probabilities of all interception points, and is calculated as follows:

$${f}_{2} = \frac{1}{N} {\sum }_{{J}^{= 1}}^{N} \frac{1}{{( 2 - 0.6 {α}_{j} )}^{{\sum }_{i = 1}^{K} {x}_{ij}}}$$

7.3) establishing constraint conditions of the optimization model;

7.3.1) to maximize police calls, all police officers belonging to the set A must and can only be assigned to a certain interception point to perform the round-up task;

$${\sum }_{j = 1}^{N} {x}_{ij} = 1 , ( i = 1 , 2 , \text{…} , K )$$

wherein xᵢⱼ=1 (i=1, 2, . . . , K; j=1, 2, . . . , N) denotes the assignment of the ith police officer in the A to the jth interception point, otherwise xᵢⱼ=0, N is a total number of interception points of the interception point set, and K is a total number of police officers in the set of police officers to be assigned;

7.3.2) it is required that a police officer assigned to a certain interception point must reach that interception point before the suspicious target

$$\frac{{D}_{ij} {x}_{ij}}{{v}_{p}} \leq \frac{{d}_{j}}{{v}_{a}} , ( i = 1 , 2 , \text{…} , K ; j = 1 , 2 , \text{…} , N )$$

Wherein Dᵢⱼ denotes a shortest distance from the ith police officer in the A to the jth interception point under the constraint of the road network, and dⱼ denotes a shortest distance from the position where the suspicious target appears to the jth interception point under the constraint of the road network; vₚ is the speed of each police officer, and vₐ is the speed of the task target;

7.3.3) xᵢⱼ is a variable of 0, 1;

xᵢⱼ={0,1}

In accordance with the above description, a multi-police-officer collaborative round-up task allocation and path planning problem under the constraint of the road network is translated into a multi-target optimization problem as shown in the following equation;

min{f₁f₂}

$$st . \{ \begin{matrix}{\sum }_{j = 1}^{N} {x}_{ij} = 1 , ( i = 1 , 2 , \text{…} , K ) \\ \frac{{D}_{ij} {x}_{ij}}{{v}_{p}} \leq \frac{{d}_{j}}{{v}_{a}} , ( i = 1 , 2 , \text{…} , K ; j = 1 , 2 , \text{…} , N ) \\ {x}_{ij} = \{ 0 , 1 \}\end{matrix}$$

wherein xᵢⱼ=1 (i=1, 2, . . . , K; j=1, 2, . . . , N) denotes the assignment of the ith police officer in the A to the jth interception point, otherwise xᵢⱼ=0, N is the total number of interception points of the interception point set, denotes the shortest distance from the ith police officer in the A to the jth interception point under the constraint of the road network, and dⱼ denotes the shortest distance from the position where the suspicious target appears to the jth interception point under the constraint of the road network; K is the total number of police officers in the set of police officers to be assigned;

8) solving the multi-police-officer collaborative round-up task allocation and path planning optimization model under the constraint of the road network by using the above constraint conditions to obtain a multi-police-officer collaborative round-up task allocation and path planning scheme.

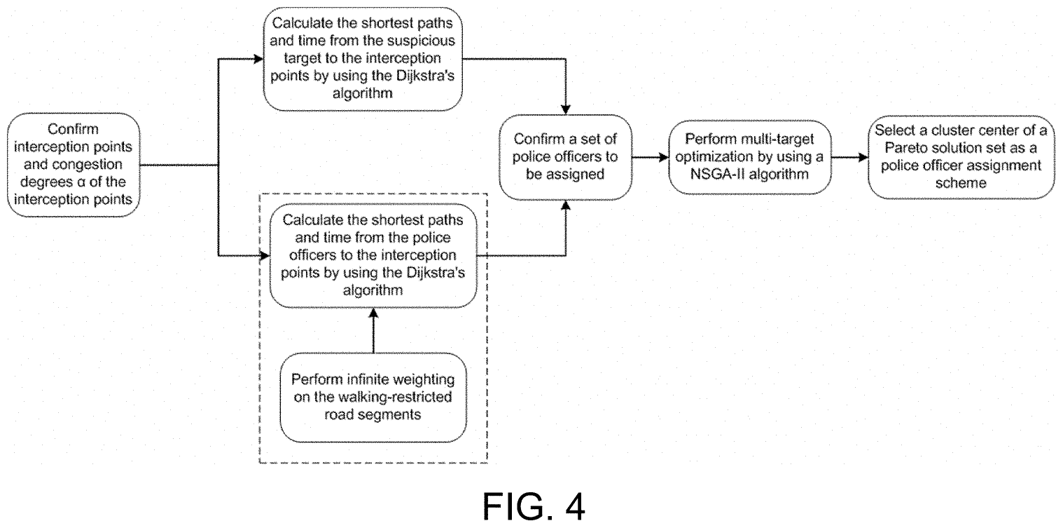

In this embodiment, the NSGA-II algorithm is employed for solving the optimization model, and the geometric cluster center of the Pareto solution set is selected as the final police officer assignment scheme, which ensuring the capture success rate and the total capture distance of all police officers as short as possible, the round-up flowchart is shown in FIG. 4.

The method of the present disclosure employs the NSGA-II algorithm for task allocation solving, and the algorithm has an efficient non-dominant solution set ranking performance, and has been widely applied in multi-target optimization problems. The NSGA-II algorithm divides an evolved population into several layers according to dominant relationships on the basis of the traditional GA algorithm, the first layer being a set of non-dominant individuals of the evolved population, the second layer being a set of non-dominant individuals obtained after removing the first layer of individuals from the evolved population, and so on. In order to maintain solution population distributivity and diversity, the NSGA-II algorithm also needs to compute the cluster distance for each individual in the evolved population, and then define a partially ordered set depending on the layer on which the individual is located and its cluster distance, and select individuals in the partially ordered set in turn when constructing the new population. Individuals with a low rank number are prioritized when constructing the partially ordered set, and individuals with larger cluster distances are prioritized when the rank is the same.

Some data operations are required when initializing the population for the problem under study. The length of the individuals of the population is first set to be equal to that of the A, and the numerical value q of the Pth number of individuals indicates that the Pth police officer in the A is assigned to the qth interception point. For example, [1 3 2 2 1] represents that there are a total of 5 police officers in the A, the first police officer is assigned to the first interception point; the second police officer is assigned to the third interception point; the third police officer is assigned to the second interception point; the fourth police officer is assigned to the second interception point; the fifth police officer is assigned to the first interception point. Each number in the individuals needs to meet the constraints at the time of population initialization, e.g., the second police officer can only reach the first and second interception points if the time constraints are met, then the second number in each individual can only be 1 or 2 at the time of particle generation.

Capture Scheme Selection Method

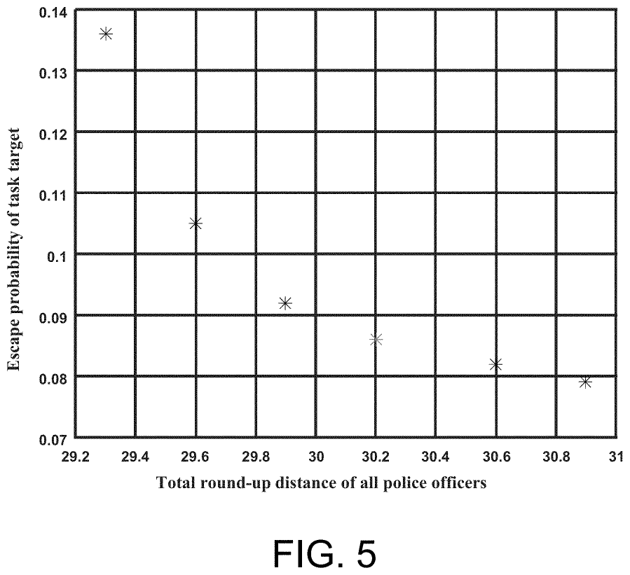

An optimal solution set is obtained by the NSGA-II multi-target optimization algorithm, as shown in FIG. 5, and all asterisk dots represent non-inferior solutions. The selection of the final solution is often very important in practical applications, and different solutions are selected according to different needs. The round-up problem studied herein requires to take into account both the total course of movement of all police officers and the escape probability of the suspicious target, so the geometric cluster center of the non-inferior solution set on the Pareto face is finally selected as the final capture scheme, the geometric cluster center is chosen as follows:

F(i)_{distance} is defined as the sum of the distances of all points on the Pareto face to the ith point, and the point corresponding to min(F_{distance}) is chosen as the cluster center. The calculation manner is as shown in an equation (8), wherein m denotes the number of non-inferior solutions on the Pareto face and F denotes the matrix of objective function values corresponding to all non-inferior solutions.

$${F ( i )}_{distance} = {\sum }_{j \neq i}^{m} \sqrt{{( F ( j , 1 ) - F ( i , 1 ) )}^{{ }^{2}} + {( F ( j , 2 ) - F ( i , 2 ) )}^{2}} \qquad ( 8 )$$

5. Experimental Results and Analysis

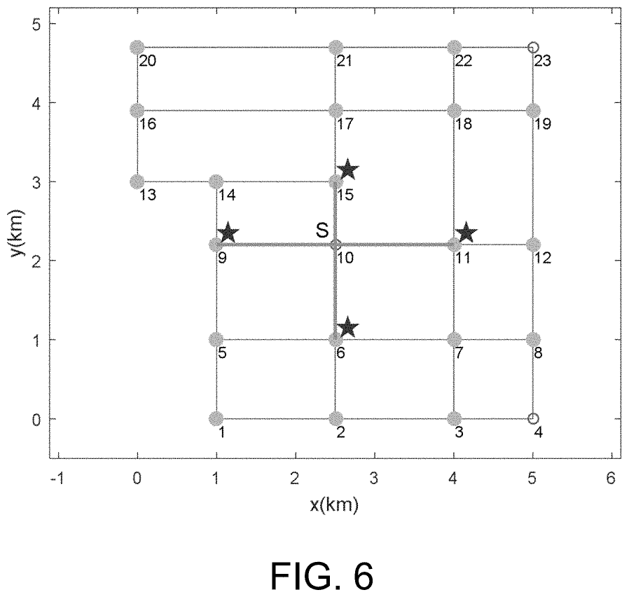

This experimental capture scenario is shown in FIG. 6. The number of intersections in the real road network is 23, with 20 police officers randomly distributed at 20 intersections on duty. The three intersections 4, 10, and 23 are unattended by the police officer, and the suspicious target appears at intersection 10, and then may appear at any of the four intersections 6, 9, 11, and 15. Based on real-time pedestrian volume and traffic flow data statistics, the congestion degrees of these four interception points are obtained as shown in the table below:

| Interception | 6 | 9 | 11 | 15 |
|---|---|---|---|---|
| point | | | | |
| intersection | | | | |
| Congestion | a₁ = 0.4 | a₂ = 0.5 | a₃ = 0.93 | a₄ = 0.15 |
| degree a | | | | |

The population size is set to be 100 and the number of iterations be 200 for this experiment using the NSGA-II algorithm.

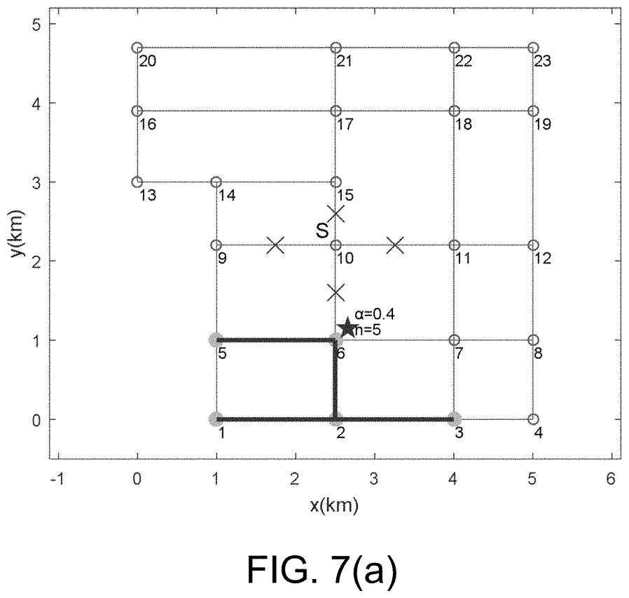

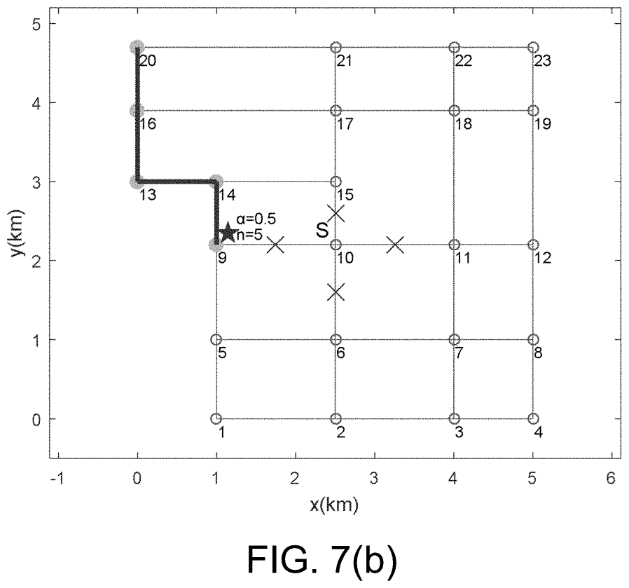

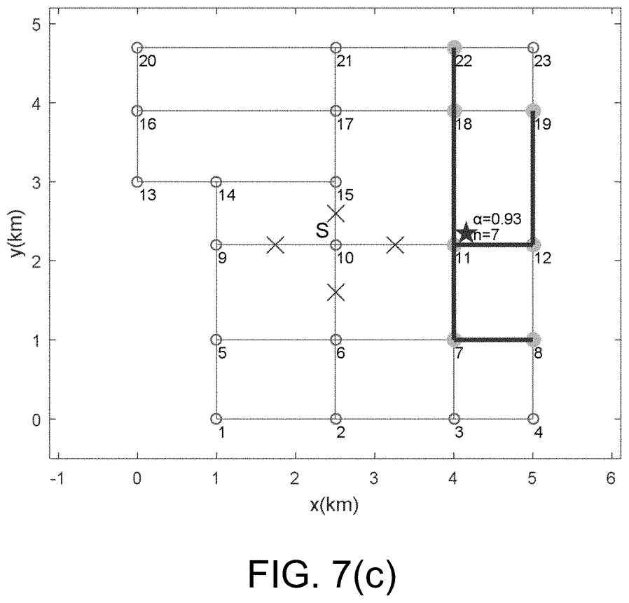

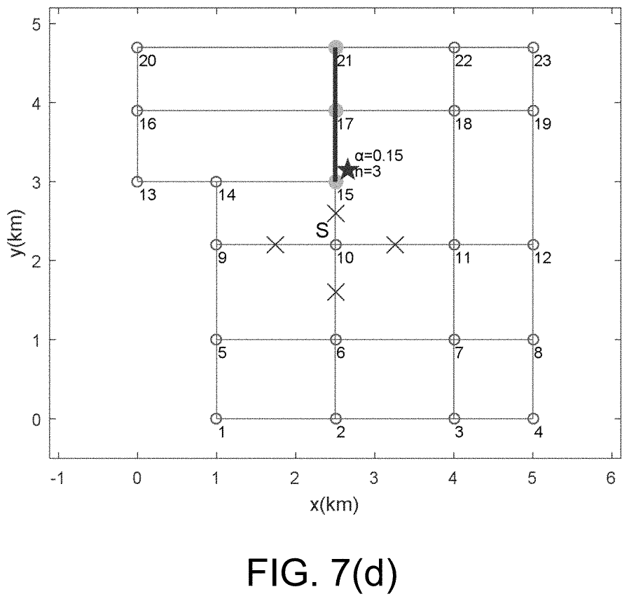

The results of the experiment are shown in FIG. 7(a)-7(d), dots denote a set of police officers assigned to the current interception point, thick solid lines denote the optimal path for police officers to move from their location in the road network to the interception point, locations marked with forks denote road segments that all police officers cannot pass through, α denotes the congestion degree of this interception point, and n denotes the number of police officers assigned to this interception point. With FIG. 7 (c) and FIG. 7 (d) as an example, the congestion degree of interception point 11 is high and is 0.93, with relatively large difficulty of capturing, and 7 police officers (7, 8, 11, 12, 18, 19, 22) assigned for capture. The congestion degree of interception point 15 is low and is 0.15, with relatively small difficulty of capturing, and 3 police officers (15, 17, 21) assigned for capture. As shown in FIGS. 7 (a) and 7 (b), interception points 6 and 9 have a congestion degree of 0.4 and 0.5, which is small in difference, with 5 police officers assigned for capture, and all police officers in the figures do not pass through the walking-restricted road segments.

Table 3 is the police officer task allocation and arrival schedule. The reachable interception point of each police officer in Table 3 indicates that the police officer can reach this interception point before the suspicious target under the constraint of time if the suspicious target selects this node as a next movement place, and the assignment of an interception point indicates to which interception point this police officer is assigned to perform the capture task. It can be seen from Table 3 that the time required for all police officers to reach the assigned interception point is shorter than the time required for the suspicious target to reach the interception point.

TABLE 3
Police Officer Task Allocation and Arrival Schedule

| | | | Time required | Time required |
|---|---|---|---|---|
| Police | Reachable | Assigned to | for police | for suspicious |
| officer | interception | interception | officer | target to |
| 1 | {6,9,11} | 6 | 0.0625 | 0.12 |
| 2 | {6,9,11} | 6 | 0.025 | 0.12 |
| 3 | {6,9,11} | 6 | 0.0625 | 0.12 |
| 5 | {6,9,11} | 6 | 0.0375 | 0.12 |
| 6 | {6,9,11} | 6 | 0 | 0.12 |
| 7 | {6,9,11} | 11 | 0.03 | 0.15 |
| 8 | {6,9,11} | 11 | 0.055 | 0.15 |
| 9 | {6,9,11, | 9 | 0 | 0.15 |
| 11 | {6,9,11} | 11 | 0 | 0.15 |
| 12 | {6,11} | 11 | 0.025 | 0.15 |
| 13 | {6,9,15} | 9 | 0.02 | 0.15 |
| 14 | {6,9,11, | 9 | 0.0575 | 0.15 |
| 15 | {9,11,15 | 15 | 0 | 0.08 |
| 16 | {9,11} | 9 | 0.0675 | 0.15 |
| 17 | {9,11,15 | 15 | 0.0225 | 0.08 |
| 18 | {6,9,11, | 11 | 0.0425 | 0.15 |
| 19 | {9,11} | 11 | 0.0675 | 0.15 |
| 20 | {9} | 9 | 0.0875 | 0.15 |
| 21 | {9,11,15 | 15 | 0.0425 | 0.08 |
| 22 | {9,11} | 11 | 0.0625 | 0.15 |

From the above experimental results, it can be seen that all police officers are able to avoid the walking-restricted road segments and select the shortest path in the road network to move to the assigned interception points before the suspicious target, and a lower number of police officers are assigned to interception points with a lower environmental complexity while more police officers are assigned to nodes with a higher environmental complexity due to greater difficulty in capturing for capture. It is well explained that the method provided herein is able to reasonably assign police officers to capture points according to time, environmental complexity and constraints on walking-restricted road segments, while optimizing the path of police officers to corresponding interception points on the road network.

It should be understood that modifications and variations can be made in light of the above description for those of ordinary skill in the art, and all such modifications and variations should fall within the protection scope of the appended claims of the present disclosure.

What is claimed is:

1. A multi-police-officer collaborative round-up task allocation and path planning method under the constraint of a road network, comprising the following steps:
1) acquiring a road topological map G=(V, E) of the road network, wherein edges E of the map denote roads, and nodes V of the map denote intersections;
2) acquiring police officer distribution information and information of a task target location in the G of the road network;
3) according to the position where a task target appears in combination with the road topological map, determining a set of nodes that the task target is next likely to reach, and defining the set of nodes as an interception point set I;
4) acquiring the movement speed of police officers and the task target;
5) confirming a set A of police officers to be assigned according to the interception point set and the movement speed of the police officers and the task target;
calculating the shortest distances from the task target and the police officers to the interception points in the road network and the corresponding time, wherein under the condition that for all interception points, the arrival time of a certain police officer is longer than the arrival time of a suspicious target, the police officer is removed from an assignment list;
6) calculating the congestion degree of each intersection in the interception point set;
7) building a multi-police-officer collaborative round-up task allocation and path planning optimization model under the constraint of the road network with the goal of minimum total round-up distance of all police officers in the set of police officers to be assigned and lowest escape probability of the task target;
8) solving the multi-police-officer collaborative round-up task allocation and path planning optimization model under the constraint of the road network to obtain a multi-police-officer collaborative round-up task allocation and path planning scheme.

2. The multi-police-officer collaborative round-up task allocation and path planning method under the constraint of the road network according to claim 1, wherein in the step 2), the task target location is detected and recognized by a camera in the road network.

3. The multi-police-officer collaborative round-up task allocation and path planning method under the constraint of the road network according to claim 1, wherein in the step 6), the congestion degree of each intersection in the interception point set is calculated by using the following equation:
$${α}_{j} = \frac{{c}_{j}}{{c}_{max}}$$
wherein αⱼ denotes a congestion index of the jth interception point; cⱼ denotes a total amount of a pedestrian volume and a traffic flow at the intersection corresponding to the jth interception point at the current moment; cₘₐₓ denotes a maximum value of the total number of the pedestrian volume and the traffic flow corresponding to all interception points at the current moment.

4. The multi-police-officer collaborative round-up task allocation and path planning method under the constraint of the road network according to claim 1, wherein in the step 7), a multi-objective function of the multi-police-officer collaborative round-up task allocation and path planning optimization model under the constraint of the road network is as follows:
7.1) a total round-up distance of all police officers in the set A of police officers to be assigned:
$${f}_{1} = {\sum }_{j = 1}^{N} {\sum }_{i = 1}^{K} {x}_{ij} {D}_{ij}$$
7.2) escape probability of the task target: a total escape probability of the suspicious target is an average value of escape probabilities of all interception points, which is calculated as follows:
$${f}_{2} = \frac{1}{N} {\sum }_{j = 1}^{N} \frac{1}{{( 2 - 0.6 {α}_{j} )}^{{\sum }_{i = 1}^{K} {x}_{ij}}} .$$

5. The multi-police-officer collaborative round-up task allocation and path planning method under the constraint of the road network according to claim 4, wherein in the step 7), constraint conditions of the multi-police-officer collaborative round-up task allocation and path planning optimization model under the constraint of the road network are as follows:
7.3) establishing the constraint conditions of the optimization model;
7.3.1) to maximize police calls, all police officers belonging to the set A must and can only be assigned to a certain interception point to perform the round-up task;
$${\sum }_{j = 1}^{N} {x}_{ij} = 1 , ( i = 1 , 2 , \text{…} , K )$$
wherein xᵢⱼ=1 (i=1, 2, . . . , K; j=1, 2, . . . , N) denotes the assignment of the ith police officer in the A to the jth interception point, otherwise xᵢⱼ=0, N is a total number of interception points of the interception point set and K is a total number of police officers in the set of police officers to be assigned;
7.3.2) it is required that a police officer assigned to a certain interception point must reach the interception point before the suspicious target
$$\frac{{D}_{ij} {x}_{ij}}{{v}_{p}} \leq \frac{{d}_{j}}{{v}_{a}} , ( i = 1 , 2 , \text{…} , K ; j = 1 , 2 , \text{…} , N )$$
wherein Dᵢⱼ denotes a shortest distance from the ith police officer in the A to the jth interception point under the constraint of the road network, and dⱼ denotes a shortest distance from a position where the suspicious target appears to the jth interception point under the constraint of the road network; vₚ is the speed of each police officer, and vₐ is the speed of the task target; and
7.3.3) xᵢⱼ is a variable of 0, 1;
xᵢⱼ={0,1}

6. The multi-police-officer collaborative round-up task allocation and path planning method under the constraint of the road network according to claim 4, wherein in the step 8), the optimization model is solved by using a NSGA-II algorithm, and a geometric cluster center of a Pareto solution set is selected as a final police officer assignment scheme.
